(19) United States
(12) Patent Application Publication
(10) Pub. No.: US 2006/0240183 A1
(43) Pub. Date: Oct. 26, 2006

(54) Asphalt surface treatment

(76) Inventors: John Peter Anthony Pollard, Sommerton Park, South Australia (AU); Naba Kumar Dutta, South Australia (AU)

Correspondence Address: DLA PIPER RUDNICK GRAY CARY US, LLP, 4365 EXECUTIVE DRIVE, SUITE 1100, SAN DIEGO, CA, 92121-2133, US

(21) Appl. No.: 10/563,398

(22) PCT Filed: Jul. 30, 2004
(86) PCT No.: PCT/AU04/01021

§ 371 Date: Apr. 19, 2006

(30) Foreign Application Priority Data
Jul. 30, 2003 (AU) 2003903954

(51) Int. Cl. B05D 5/10

(52) U.S. Cl. 427/138

(57) ABSTRACT

A method and composition for treating a weathered low traffic volume asphalt surface. The method comprising the steps of providing a composition comprising a solution, emulsion or dispersion of a polymer material, particulate material, rheology modifiers, processing aids, and UV absorbers, wherein the composition is essentially free of bituminous components and is essentially free of cement; and applying the composition to the asphalt surface. The composition preferably is a shear thinning formulation which exhibits a marked reduction in viscosity when sprayed or otherwise subjected to shear during application but increases in viscosity after application.

### FIELD OF THE INVENTION

The present invention relates to a composition and a method for coating an asphalt wearing course.

### BACKGROUND OF THE INVENTION

Asphalt wearing courses are extensively used in the construction of roads, carparks, driveways and hard stand areas.

Asphalt wearing courses generally comprise mixtures of asphaltic binder, graded aggregates, sands, fillers and additives. Asphalt wearing courses include hot mixed asphalts, chip seal surfacing, micro surfacing and any other structural wearing course having a layer of aggregate mixed with or dispersed upon an asphaltic binder.

Although providing relatively cost effective wearing courses, because of the chemical nature and thermal instability of the asphaltic binder they are susceptible to degradation as a result of weathering. As asphalt wearing courses weather the less durable asphalt binder/sand mixture degrades and tends to erode from the pavement surface. This creates what is known in the industry as a “pavement texture depth” in which the larger aggregate particles contained within the mixture extend above the upper surface of the eroded asphalt binder/sand particles. Continued weathering of asphalt wearing courses causes a loss of ductility of the asphaltic binder, the disintegration and ravelling of the wearing course, surface cracking, moisture ingress to the underlying pavement layers and risks unnecessary breakdown of the structural integrity of the pavement.

Central to the present invention is the distinction between low traffic volume roadways (such as those often maintained by local governments and the like) and main arterial roads (such as those often maintained by main road or federal authorities).

Low traffic volume road wearing courses tend to develop pavement texture depth and progress to eventual disintegration as a result of the effects of weathering, whereas main/arterial road wearing courses tend to be worn away and degrade as a result of both high traffic volumes and large structural loadings.

Industry developments since the 1960's to reduce the susceptibility of asphalt surfacings to the effects of weather have included the blending of small amounts of polymeric material (typically EVA and SBS types) into the asphalt binder. More durable asphalt wearing courses for low traffic volume roads are provided by the adoption of hybrid “gap graded” asphalt mixes where the aggregate/sand/asphalt binder proportions within the mixture are altered from traditional specifications to provide a more weathering resistant surface. Whilst both of the above developments provide a measure of improvement over conventional asphalt surfacing they are considerably more expensive.

In addition to the surfacing treatments above, other methods of improving low traffic volume roadways include:
(a) preparing the pavement surface and resealing the wearing course with another layer of hot mixed asphalt;
(b) surface treatment processes including micro surfacing, asphaltic slurry seals, asphalt chip seals, asphalt sand seals and the like; and
(c) asphalt rejuvenation or enrichment processes that solvate and/or replace lost components of the asphaltic binder.

All of the above methods provide shortcomings either as economic or environmental solutions and are prone to the same weathering and replacement cycle as the surfaces they are covering.

It is the object of the present invention to provide a cost effective polymeric coating, formulated to provide excellent weathering properties that can effectively prevent further deterioration of asphalt surfaces. It is when adequate pavement texture depth is formed on the weathered pavement that the present invention can effectively protect the asphalt binder/sand mixture from further disintegration without being abraded by the action of vehicle tyres traversing the pavement.

Prior art examples of asphalt surface treatments include U.S. Pat. No. 4,851,456 to Dean, which describes a paste-like topcoat for surfaces. The topcoat composition comprises dry mix materials and liquid mix materials. The dry mix materials comprise sand, cement and a resinous binder. The resinous binder is preferably a cellulosic binder. The liquid mix materials comprise water, vinyl acrylates and/or methacrylate, and a solvent for at least one of the vinyl acrylates and resin binders. This composition is particularly useful as a topcoat for asphalt.

U.S. Pat. No. 5,578,663 describes a pavement rejuvenating and/or conditioning composition in which particular coal tar derivatives and other optional ingredients are supplemented with an elastomeric constituent. The elastomer may be incorporated as a latex, in solution or in the melt or as finely divided particles or fibrils. The coal tar derivatives are described as being a mixture of di-, tri- and tetra-cyclic aromatic compounds and their alkyl homologs containing lower alkyl groups together with a significant amount of phenolic and hydroxy derivates.

U.S. Pat. No. 6,113,978 relates to methods and compositions which comprise applying certain cationic fluorinated copolymer compositions to asphaltic material to protect the asphaltic material from damage from water, oil and weather. This patent teaches that using cross-linked resins or physical mixtures with a polymeric film former that form coatings which seal the surface of the substrate is undesirable as they give the substrate an aesthetically undesirable shiny and unnatural appearance, and will normally make a surface more slippery and prevent water drainage. In the invention described in this patent, it was found that asphaltic materials can be provided with increased resistance to damage from water, oil and weather while remaining porous and retaining a natural appearance.

The method of this earlier patent involves treating the asphaltic material with a composition comprising a dilute aqueous solution or a self-dispersed emulsion or dispersion of certain cationic, fluorinated copolymers, optionally in the presence of an effective amount of a penetration assistant. The penetration assistant is described as being any surface active organic substance that enhances the ability of an aqueous solution or self-dispersed emulsion or dispersion of the copolymer to penetrate and set out an asphaltic substrate. Examples include non-ionic, cationic or amphoteric surfactant. The patent states that a porous substrate largely retains its porosity after the inventive treatment, so air and moisture vapour can still pass through.

Other prior art examples of asphalt surface treatments include formulations containing asphalt binder, asphalt emulsion, coal tar derivatives or cement. The use of asphalt binder or emulsified asphalt in sealing formulations provides for a coating which, as a result of the chemical nature of the asphalt binder is prone to softening at relatively low temperature, typically from about 43° C. in the case of unmodified asphalts and 65° C. in the case of polymer modified asphalt binders.

The relatively low softening point of the formulations causes “picking up” of the formulation under vehicle tyres in warm weather.

Coal tar or coal tar derivatives should also be avoided as they are suspected carcinogens, and frequently contain hydrocarbon solvents as cutting agents, which cause damage to the environment. They are also subject to lengthened curing times which render the coating prone to tracking.

Cement based coatings, either co-formulated with asphalt binder in the case of asphaltic slurries or in conjunction with a polymeric material are also restrictive. As a result of hydration (the chemical reaction between cement and water) the coatings are required to be mixed on site immediately prior to use and have limited application time. Cement based formulations, even those that are polymer modified, are also susceptible to shrinkage as the formulation water evaporates from the coating mixture. Additionally these rigid coatings have low flexural strength and are prone to cracking, thus avoiding their advantage as a pavement sealer.

### SUMMARY OF THE INVENTION

In the first aspect, the present invention provides a method for treating a weathered low traffic volume asphalt wearing course comprising the steps of:

providing a composition comprising a solution, emulsion or dispersion of a polymeric material, particulate material and rheology modifiers, wherein said composition is essentially free of bituminous components and is essentially free of cement; and

applying the composition to the asphalt surface.

The composition may further comprise pigments and UV absorbers.

In a preferred form, the composition comprises 10-60% wt, preferably 40-60% wt polymer binder material, 5-20% particulate material, preferably 10-20%, 1-10% rheology modifiers, preferably 2-6% wt and the remainder being water, UV absorbers, processing aids such as surfactant, pH controllers and dispersants.

Preferably, the composition is applied to the asphalt surface using high volume low pressure (HVLP) spray technology. However, other methods of application of the composition, such as by conventional spray, mechanised squeegee or slurry machine, or indeed any other application method known to be suitable by the person of skill in the art also fall within the scope of the present invention.

The composition used in the first aspect of the present invention includes a solution, emulsion or dispersion of a polymeric material. Preferably, an aqueous polymeric emulsion is used.

The solution, emulsion or dispersion of a polymeric material suitably includes one or more polymeric materials that form a film upon setting. In this fashion, the polymeric material will seal any minor cracking in the asphalt surface. The polymeric material can also protect the weathered asphalt binder to prevent further weathering and moisture ingress into the underlying base course and thereby prevent structural damage, which is expensive to repair.

The polymeric material used in the method of the present invention is preferably an aqueous emulsion containing an acrylate. Other polymeric systems such as water borne polyurethane or water borne epoxies that are film-forming may also be used.

The composition applied to the asphalt surface also includes particulate material. The particulate material may be selected from sand, mineral aggregates, rubber particles, or a mixture of two or more thereof. Rubber particles are preferred. Most suitably, the rubber particles are graded, recycled crumb rubber, such as those rubber particles available from companies involved in the recycling of vehicular tyres. The rubber particles may be treated with a coupling agent to improve bonding between the rubber particles and the polymer and provide a more uniform distribution of the particles within the coating film.

The particulate material also acts as a UV resistant, durable filler. Where rubber particles are used, the rubber particles have the added benefit of being wear and chemical resistant.

For use on weathered asphalt surfaces, it is preferred that the composition is applied to the asphalt surface in a fashion such that any protruding aggregate in the asphalt surface is largely not covered with the coating. If protruding aggregate is covered by the coating, the coating will eventually wear off under the abrasive action of vehicle tyres. In this embodiment of the method of the present invention, the composition preferably does not cover the aggregate on the asphalt surface, but rather covers the voids or interstices between the aggregate particles formed as a result of weathering of the asphaltic binder/sand mixture and thereby protects the asphaltic binder/sand mixture from further degradation.

To provide a coating depth which provides for protruding aggregate, a number of procedures, either chemical or mechanical or resulting from the rheological behaviour of the coating or a combination of all three, may be employed prior to, during or after application of the coating.

For example, to prevent the coating adhering to the top surface of the protruding aggregate, a chemical bond breaking material may be applied sparingly by using a large diameter application. A large diameter application, such as a multi-tyred roller or similar, can be used to transfer the bond breaking solution to the top surface of the protruding aggregates whilst bridging the voids or interstices below and therefore only subject the aggregates to the bond breaking solution. In this manner, the voids or interstices would be untreated by the bond breaking solution and therefore readily bond to the coating solution.

Other methods of ensuring uncoated protruding aggregate may be to remove the excess coating by mechanical means, such as by scraping the top surface of the aggregates prior to film formation of the coating. Still another method of removing the coating may be to lightly displace the coating film from the top of the protruding aggregates by contacting the road surface with a small steel diameter, such as a steel drummed roller or similar.

A preferred method to minimise or avoid the amount of polymer that coats the surface aggregate on the weathered asphalt surface is to use a shear thinning formulation that displays a marked decrease in viscosity as the formulation is applied. When the coating composition is sprayed onto the asphalt surface, it is preferable that the coating composition displays a marked decrease in viscosity when shear is applied and an increase in viscosity when the shear is no longer applied. For the application of the coating composition, this shear thinning behaviour is preferably embodied as at least a two order of magnitude decrease in viscosity when the shear rate is increased from 1-2000 l/s and preferably at least a three order of magnitude decrease.

In applications where the method of the first aspect of the invention is to be applied, it is preferred that rubber particles having a maximum size of less than 500 μm and preferably 250 μm are mixed into the composition to be applied to the asphalt surface. It is also preferred that the application rate of the composition to the asphalt surface will result in a thickness of between 200 and 300 μm being applied to the asphalt surface.

The method of the present invention may include the further steps of cleaning and preparing the asphalt surface prior to applying the composition thereto. The cleaning and preparation of the asphalt surface may include using a mechanised sweeper, vacuum or air blower to remove solid material from the asphalt surface. It may also involve repairing structural defects, such as potholes, prior to applying the composition.

In a second aspect, the present invention provides a composition for coating a weathered asphalt surface comprising a solution, emulsion or dispersion of a polymeric material and particulate material, wherein said composition is essentially free of bituminous components and is essentially free of cement.

Preferred embodiments of the second aspect of the invention are as described with reference to the preferred embodiments of the first aspect of the present invention.

In a third aspect, the present invention provides a composition for coating a weathered asphalt wearing course comprising a solution, emulsion or dispersion of a polymeric material and particulate material, wherein said composition is quick drying, enabling the asphalt wearing course to be trafficked shortly after application of the coating.

Preferred embodiments of the third aspect of the invention are as described with reference to the preferred embodiments of the first aspect of the present invention

The present invention provides an economical, environmentally sound, resilient and aesthetically pleasing polymeric coating composition to prevent damage, rectify damage and arrest the ageing process of weathered asphalt surfaces. Preferred embodiments of the present invention utilise processed scrap rubber, either as a durable filler or a surface bonded component within the polymeric coating. The composition forms a polymeric film upon setting. In areas, it is preferred that the polymeric film does not cover the protruding aggregate in the asphalt surface. In this embodiment, the protruding aggregate on the asphalt surface provides the desired wear properties for the trafficked surface whilst the polymeric mixture will be protecting the asphalt binder in the voids below the aggregate.

Preferred embodiments of the present invention utilise aqueous emulsions of polymeric materials. Suitable emulsions include commercially available products such as Primal 2133, an anionic carboxylic functional styrene acrylic emulsion sold by Rohm & Haas, Primal PR-1042, an anionic pure acrylic based upon the copolymerisation of methyl methacrylate and butyl acrylate also sold by Rohm and Haas. Other suitable commercially available acrylic emulsions include “Viscopol” sold by Nuplex and “Acronal” sold by BASF.

### DETAILED DESCRIPTION OF THE INVENTION

Further features objects and advantages of the present invention will become more apparent from the following description of the preferred embodiments and accompanying drawings in which:

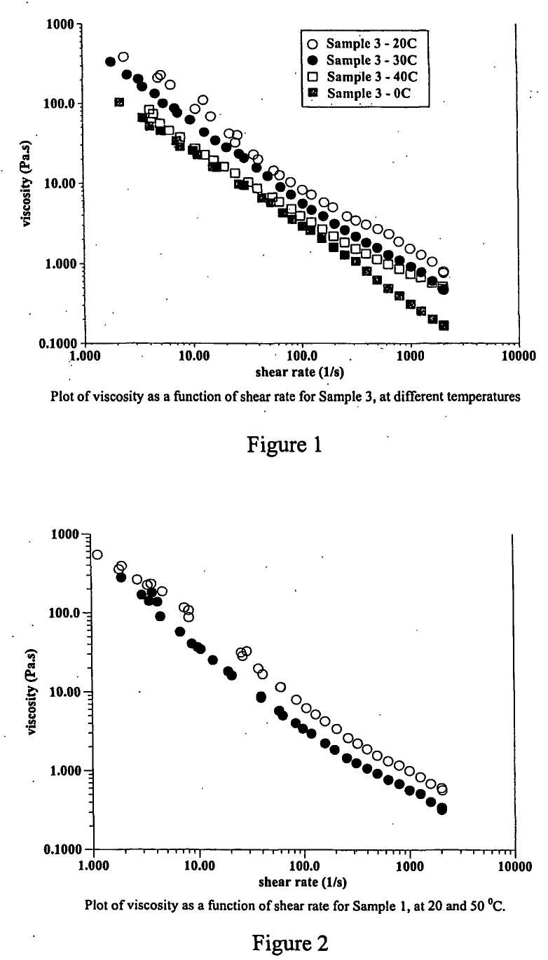

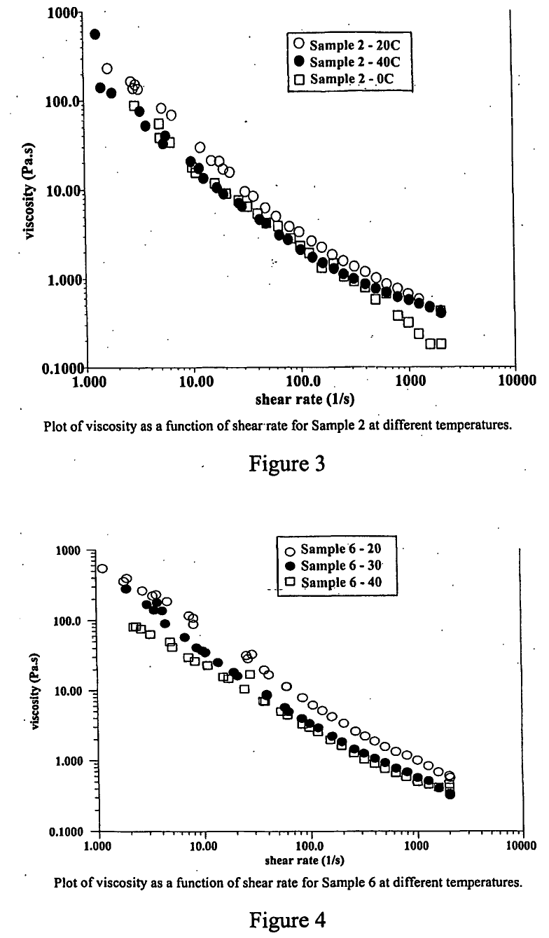

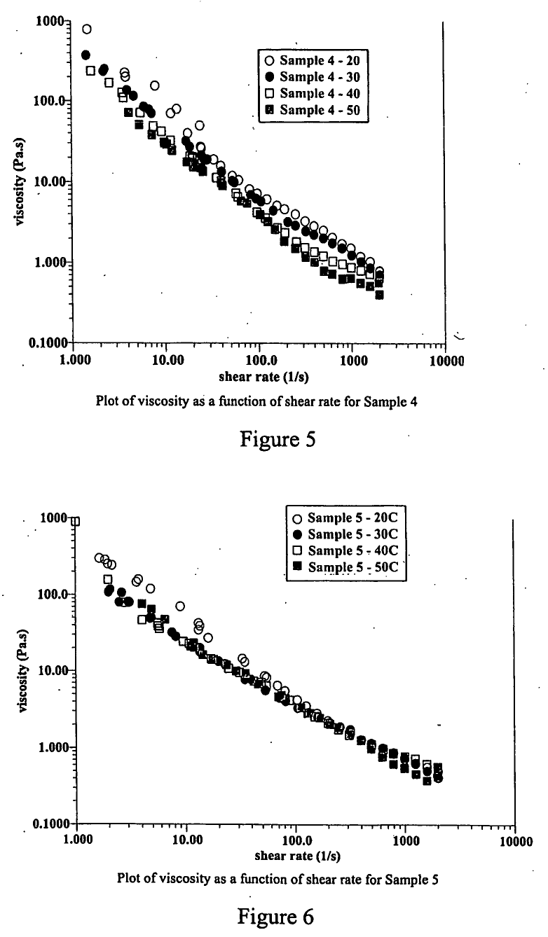

FIGS. 1-10 are graphs illustrating the rheological behaviour of the compositions exemplified;

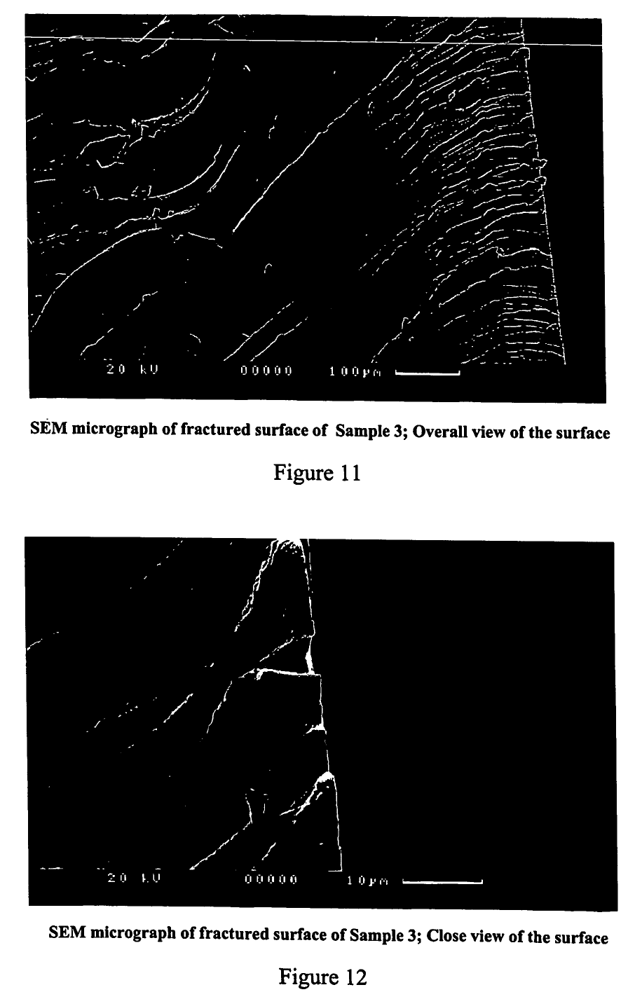

FIGS. 11 and 12 are Scanning Electron Microscope (SEM) micrographs of surfaces of Sample 3;

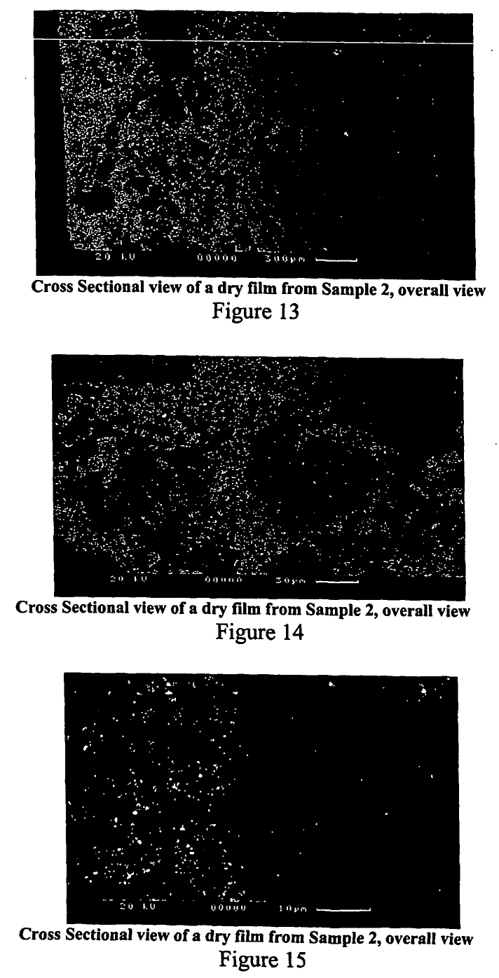

FIGS. 13-15 are SEM micrographs of the surface of Sample 5;

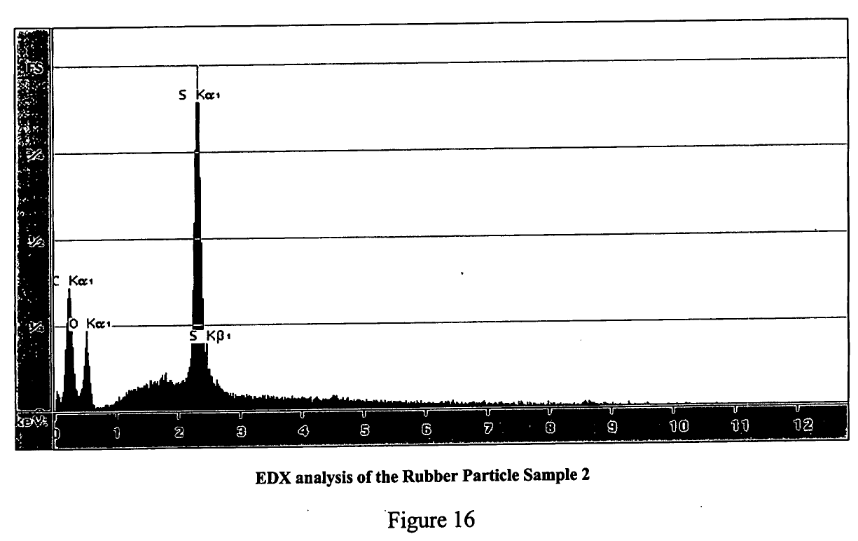

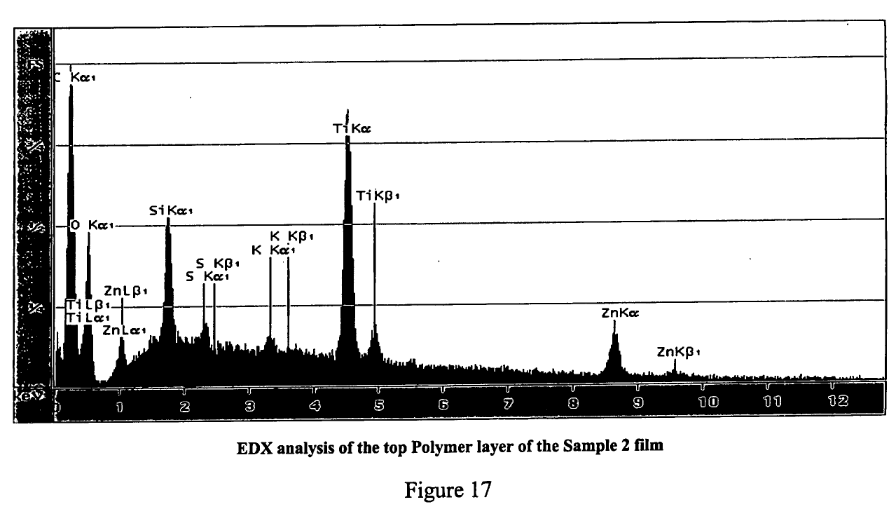

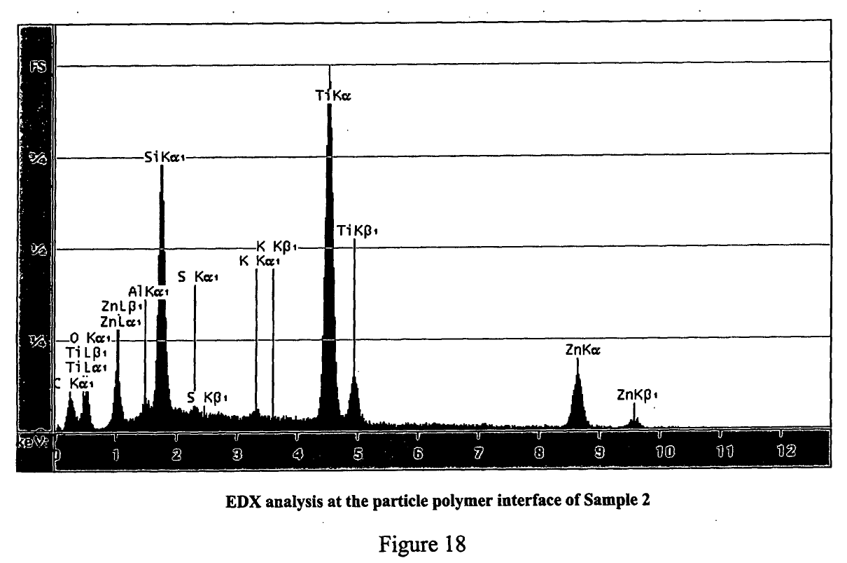

FIGS. 16-18 are an Energy Dispersive X ray spectroscopic analysis (EDX) analysis of Sample 5;

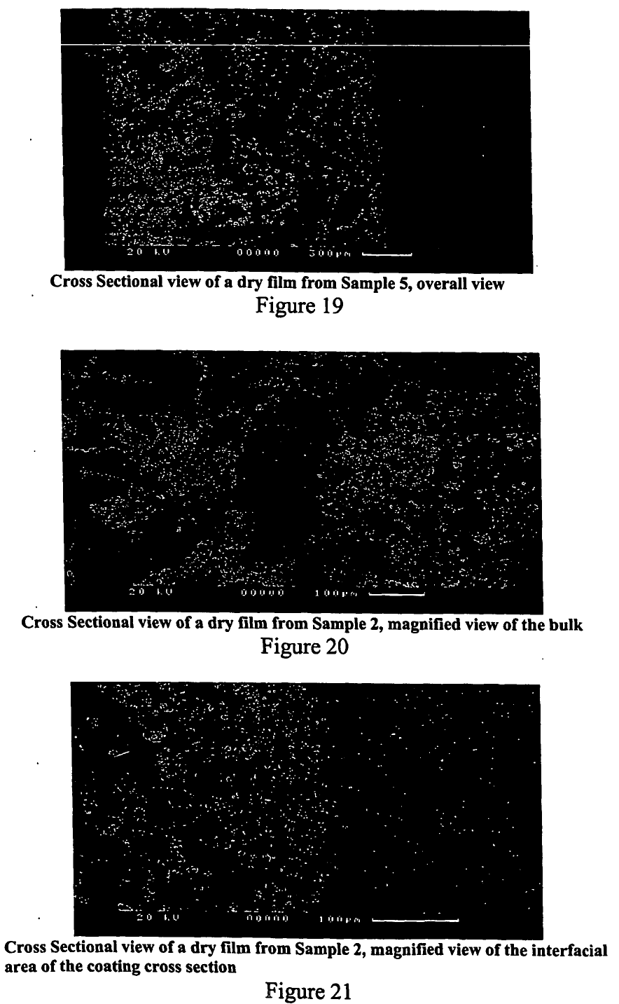

FIGS. 19-21 are magnified cross-sectional views of a dry film of Sample 5;

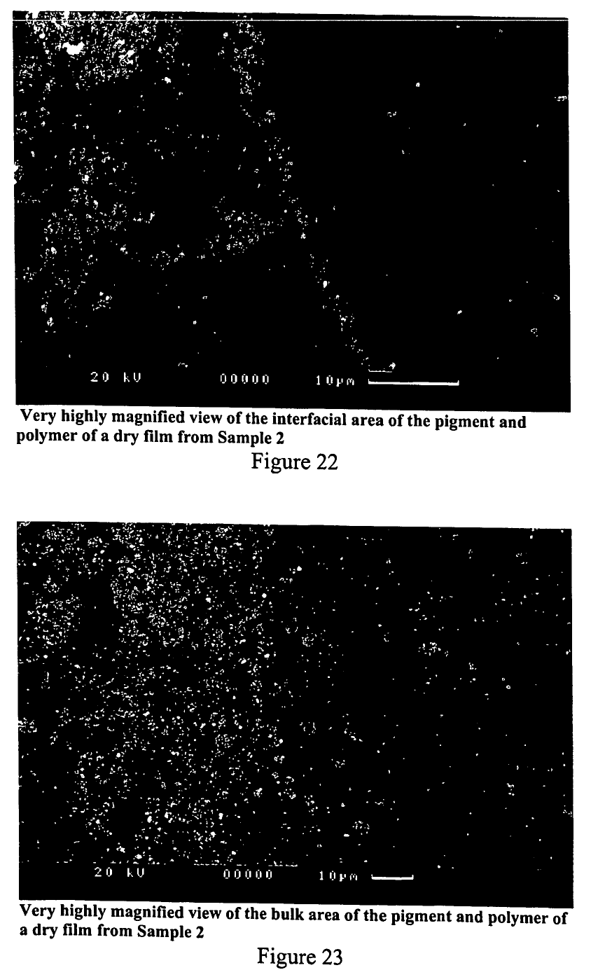

FIG. 22 is a magnified view of the interfacial area of pigment and polymer of a dry film of Sample 5;

FIG. 23 is a magnified view of the bulk area of the pigment and polymer of a dry film of Sample 5;

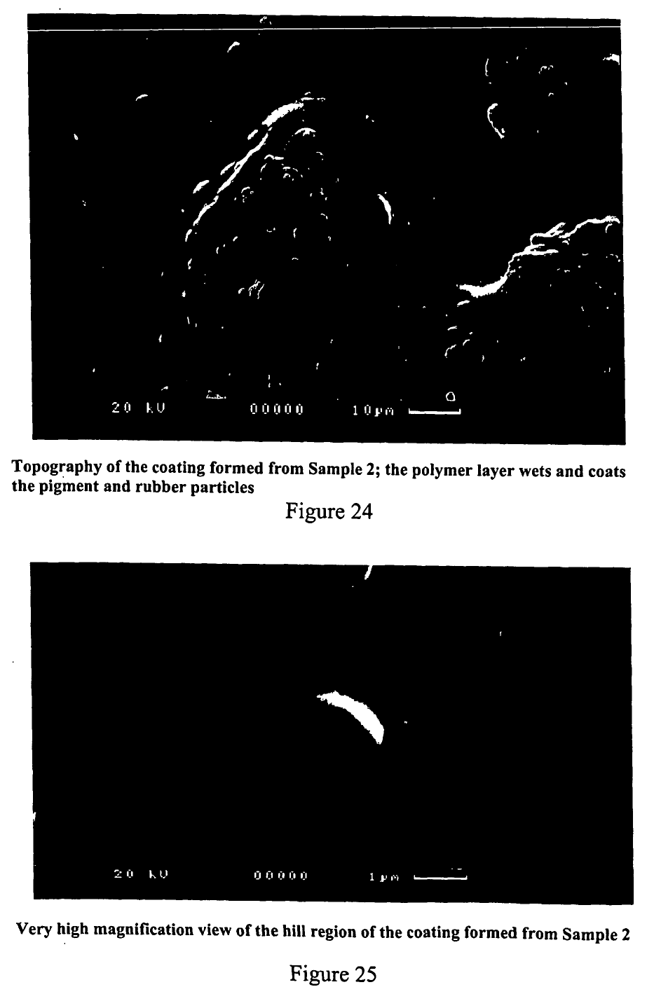

FIGS. 24 and 25 are a representative topography of a coating surface of the invention formed on a smooth glass surface;

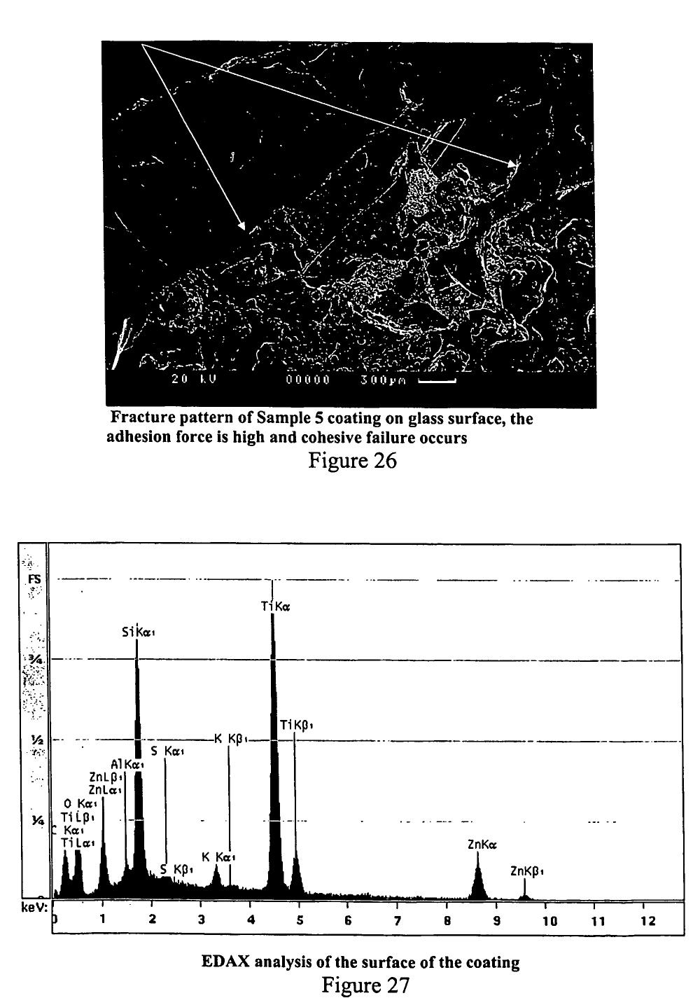

FIG. 26 is an SEM of an adhesion failure pattern of a Sample 5;

FIG. 27 is an EDX analysis of the coating of FIG. 26.

### FORMULATION INGREDIENTS

The details of the raw materials used for the coating development and their manufacturers/suppliers are given in Table 1 (a) The function of each of the raw materials in the formulation is shown in Table 1(b). The formulation contains recycled ground rubber, from scrap tyres, which provides economic, environmental, and functional benefits. Typically the chemical composition of the recycled tyre rubber comprises a vulcanised mixture of either natural or synthetic rubber (poly butadiene rubber or styrene butadiene rubber) carbon black, sulphur and plasticiser.

TABLE 1 (a)
List of raw materials used for the formulation

| | | Manufacturer/ |
|---|---|---|
| Material | Trade Name | Supplier |
| Poly(oxy-1,2-ethanediyl),.- | Triton CF-10 | Dow Chemicals |
| (phenylmethyl)-.-[(1,1,3,3- | | |
| tetramethylbutyl)phenoxy]-Octyl | | |
| phenol reacted with ethylene | | |
| oxide | | |
| Carboxylic acid sodium salt | Orotan 850 | Rohm & Haas |
| dispersant | | |
| Tetrapotassium Pyrophosphate | | Local Supplier |
| Diethylene Glycol Butyl Ether | | Local Supplier |
| Aqueous Ammonia | | Local Supplier |
| Hydroxyethylcellulose | Natrosol 250MR | Hercules |
| | | Incorporated |
| Hydrophobically modified | Acrysol RM-12W | Rohm & Haas |
| ethylene oxide urethane | | |
| (HEUR) | | |
| Hydrophobically modified | Acrysol RM- | Rohm & Haas |
| ethylene oxide urethane | 2020NPR | |
| (HEUR) | | |
| 5-chloro-2-methyl-4isothiazolin- | Kathon LXE | Rohm & Haas |
| 3-one and 2-methyl-4- | | |
| isothiazolin-3-one | | |
| (CMIT MIT type) | | |
| Proprietary Defoamer | Foamaster NXZ | Cognis Australia |
| | | Pty Ltd |
| Recycled crumb rubber | 60 mesh | Environmental |
| | 500 micron minus | Rubbertec |
| | | Australia |
| Hydrophilic Amorphous Silica | Wacker HDK T40 | Wacker |
| | | Chemicals |
| Silicon Dioxide Matting Agent | Acematt OK 412 | Degussa |
| Hydrophilic Fumed Silica | Aerosil 200 | Degussa |
| Zinc Oxide | | Local Supplier |
| Carbon Black | Raven 1255 | Columbian |
| | | Chemicals |
| | | Company |
| Propylene Glycol | | Local Supplier |
| Dibutyl Phthalate | | Local Supplier |
| N(beta-aminoethyl) gamma- | Silquest A-1120 | OSi Specialties |
| aminopropyltrime-thoxy silane | Silane | |
| Methyl methacrylate and butyl | Primal PR 1042 | Rohm & Haas |
| acrylate, plus a patented | | |
| proprietary cross-linker | | |
| Styrene acrylic emulsion with | Primal 2133 | Rohm & Haas |
| carboxylic functionality | | |
| Titanium Dioxide | Ti-Pure | Dupont |
| Crushed Quartz (300 micron | | Barossa Quarries |
| minus) | | |

TABLE 1 (b)
Function of raw materials used in the formulation

| Formulation Ingredient | Function |
|---|---|
| Triton CF - 10 | Surfactant, wetting agent. |
| Orotan 850 | Dispersing aid, Zinc Oxide stabilizer. |
| Tetrapotassium Pyrophosphate | Provides thermal stability to cured film, |
| | Free radical scavenger to prevent |
| | oxidization |
| Diethylene Glycol Butyl Ether | Coalescent |
| Aqueous Ammonia | pH Control |
| Natrosol 250MR | Viscosity (thickening) agent, stabilizing |
| | agent, |
| Acrysol RM-12W | Viscosity (thickening) agent, stabilizing |
| | agent, enhances formulation flow and |
| | levelling, improves film formation |
| Acrysol RM-2020NPR | Rheology modifier, enhances flow and |
| | levelling, improves film formation, |
| | enables high shear(film build) viscosity. |
| Kathon LXE | Preservative |
| Foamaster NXZ | Broad spectrum, general purpose |
| | defoamer |
| Recycled Crumb Rubber | Eco-friendly filler, Pigment |
| Wacker HDK T40 | Thickening and anti settling agent, |
| | enhances shear thinning |
| Acematt OK 412 | Matting agent, enhances shear thinning |
| Aerosil 200 | Assists shear thinning, provides |
| | corrosion resistance to cured film |
| Zinc Oxide | Enhances film moisture barrier, UV |
| | absorber, filler |
| Raven 1255 | Pigment, reinforcer, UV absorber |
| Propylene Glycol | Wet edge extender |
| Dibutyl Phthalate | Plasticizer |
| Silquest A-1120 Silane | Coupling agent, |
| Primal PR 1042 | Binder |
| Primal 2133 | Binder |
| Ti-Pure | UV absorber, filler |
| Crushed Quartz | Provides skidding resistance, Matting |
| | agent |

Processed Graded Rubber from Scrap Tyres.

The selection of the particulate vulcanised rubber particle size distribution/specific surface area is very important in designing a ground rubber based coating formulation. The finer the ground rubber particles the better will be the modification efficiency and smooth finish for lower coating thickness. The thickness of the coating should be at least equal to the diameter of the ground rubber particle used to achieve good adhesion, stability and durability of the dry film from the coating. The distribution of the particle sizes of the vulcanised crumb rubber particles used is given in Table 2.

TABLE 2
Particle size distribution of the rubber particles

| Sieve Size μ | % Passed (by weight) | % Retained (by weight) |
|---|---|---|
| 500 | 100 | 0 |
| 425 | 76 | 24 |
| 300 | 42 | 58 |
| 180 | 10 | 90 |
| 100 | 3 | 97 |

Final Formulations.

Table 3 provides details and designation of the formulations developed for further evaluation. All quantities are noted by weight.

TABLE 3
formulation of the developed conformal coatings

| | Sample 1 | Sample 2 | Sample 3 | Sample 4 | Sample 5 | Sample 6 |
|---|---|---|---|---|---|---|
| GRIND | | | | | | |
| Water | 63.31 | 63.31 | 63.31 | 63.31 | 63.31 | 63.31 |
| Propylene Glycol | 21.10 | 21.10 | 21.10 | 21.10 | 21.10 | 21.10 |
| Oraton 850 | 11.07 | 11.07 | 11.07 | 11.07 | 11.07 | 11.07 |
| KTPP | 2.32 | 2.32 | 2.32 | 2.32 | 2.32 | 2.32 |
| Triton CF-10 | 2.11 | 2.11 | 2.11 | 2.11 | 2.11 | 2.11 |
| TiO2 | 73.86 | 73.86 | 73.86 | 73.86 | 73.86 | 73.86 |
| ZnO | 31.65 | 31.65 | 31.65 | 31.65 | 31.65 | 31.65 |
| Carbon Black | 31.65 | 31.65 | 31.65 | 31.65 | 31.65 | 31.65 |
| Crumb Rubber | 105.51 | 105.51 | 105.51 | | | |
| Treated Crumb Rubber | — | — | — | 105.51 | 105.51 | 105.51 |
| Acematt OK412 | 31.65 | 31.65 | 31.65 | 31.65 | 31.65 | 31.65 |
| Aerosil | 15.82 | 15.82 | 15.82 | 15.82 | 15.82 | 15.82 |
| Natrosol 250MR | 1.58 | 1.58 | 1.58 | 1.58 | 1.58 | 1.58 |
| LET DOWN | | | | | | |
| Primal 2133 | 422.07 | 211.03 | | 422.07 | 211.03 | |
| Primal-PR1042 | | 211.03 | 422.07 | | 211.03 | 422.07 |
| Foam Master NSZ | 1.05 | 1.05 | 1.05 | 1.05 | 1.05 | 1.05 |
| Kathon LXE | 1.58 | 1.58 | 1.58 | 1.58 | 1.58 | 1.58 |
| DGBE* | 31.65 | 31.65 | 31.65 | 31.65 | 31.65 | 31.65 |
| DBP** | 16.88 | 16.88 | 16.88 | 16.88 | 16.88 | 16.88 |
| Water | 126.62 | 126.62 | 126.62 | 126.62 | 126.62 | 126.62 |
| Acrysol RM-12W | 2.11 | 2.11 | 2.11 | 2.11 | 2.11 | 2.11 |
| Acrysol RM2020NPR | 1.05 | 1.05 | 1.05 | 1.05 | 1.05 | 1.05 |
| NH4OH | 5.27 | 5.27 | 5.27 | 5.27 | 5.27 | 5.27 |
| TOTAL(APPROX) | 1000 | 1000 | 1000 | 1000 | 1000 | 1000 |

DGBE: Diethylene Glycol Butyl Ether
DBP: DibutylPhthalate
Treated Crumb Rubber: Crumb rubber treated with 2.5-5 wt % Silquest ® a-1120 Silanes.

Processing Procedure

The composition manufacture comprises the following steps;
Proportioning and mixing the formulation solids with vehicle and surface-active agents to make a paste, which has the right consistency for grinding.
Grinding the paste in a mill until the formulation solids aggregates are broken down into individual particles.
Let down the ground paste with the remainder of the components in the formulation.
Testing the batch for the desired physical properties.

Mixing: in order to obtain maximum efficiency in the mixing operation part of the vehicle should be added first followed by sufficient solids to produce a very stiff paste; additional increments of solids and vehicle should be added until all the required solids are in the mixture.

Grinding: Note that the term ‘grinding’ is a common term in coating formulation and is therefore used here, however at this stage actual reduction in size of the particles does not occur. The formulation solids manufacturers and the manufacturing process determines the particle size, however, the formulation solids consist of aggregates and not the ultimate particles. The purpose of grinding is to break down the aggregates and disperse the ultimate sized particle in the vehicle. The mill/dispersing equipment performs the work required. The dispersing agents stabilize the solids dispersion to prevent flocculation when the formulation is let down.

Note that the dispersing force/action differs in the different types of the equipment used. In many cases it is principally a shearing action, in others it may be attrition of pigment aggregates against one another; impact/crushing also occur to a limited extent. However, the most common and effective action is shearing. For economic and technical reasons it is desirable to grind the maximum possible solids concentration consistent with being able to achieve bulk blending of the formulation. With high shear thinning formulations of the type preferred in this invention, mixtures which do not flow and cannot be blended at low shear rates can become quite fluid when subjected to high rates of shear.

Let Down: Charge tanks are used for thinning paste with letdown materials. Normally there should not be any difficulty in thinning down a properly prepared paste with the remainder of the vehicle and other letdown materials. However, if the paste is a soft gel like structure, the paste should be stirred thoroughly and the vehicle added slowly until the gel is reduced down to a smooth flowing consistency, before adding the diluent. If the paste is thinned too rapidly, small particles of the gel will be formed, which are very difficult to break down in the liquid coating.

Evaluation of the Coating

The performance of a coating is highly dependent on its physical, mechanical and chemical properties and its variation with time and temperature. A variety of thermodynamic, thermo-mechanical, rheological, spectroscopic and microscopic methods have been employed to evaluate the coatings in significant detail.

Processing Characteristics of the Coating-Rheological Characterization

The rheological behaviour of the coating dictates the process-ability, anti-settling properties, application, method of application, and quality of the film formation and provides the ultimate properties of the cured coating. The processing of latex based coatings is crucially dependent on the rheological additives and modifiers incorporated into the formulation. Depending on the final desirable characteristics, and end-use market, latex based coating may contain multiple rheological additives. A combination of additives is used to achieve the required good balance of rheological profile of container viscosity, application viscosity, anti-settling properties, spatter resistance, flow and levelling. The balanced Theological characteristics of the finished formulation are the most important aspect rather than the individual viscosity improvers employed.

Viscosity is the most important material processing property and may be explained as the measure of resistance to flow by liquid materials as a result of internal frictions. Viscosity, in the case of Newtonian liquids is essentially constant and independent of shear rate and is called the coefficient of viscosity, η. However, for non-Newtonian liquids η is not a constant rather a function of shear rate and this parameter is defined as the function η (γ^{·}) and is known as the shear viscosity. Hence viscosity of non-Newtonian liquids may be defined as the resistance to flow opposed by materials, which is dependent on the shear rate at a given temperature and/or time.

The coating emulsions were investigated under steady shear condition using cone and plate configuration. The rheological investigation was carried out using an AR 1000N (TA Instruments, Delaware), which may provide either controlled stress or controlled-rate experiment and can measure viscosity from very low to very high shear rates.

The cone and plate geometry consists of a truncated stainless steel cone that rotates under shear and has a 40 mm diameter with an angle of 2° C. The sample is placed within the cone and the plate and is subjected to variable shear rate. The edge of the sample is aligned with the apex of the cone in order to produce optimum results (an under-filled or over filled cone and plate gap will produce incorrect results). The experimental shear rate range employed was between 0.1 to 2000 l/s.

FIG. 1-10 shows the rheological behaviour of the coating emulsions examined. Viscosity as a function of shear rate for the coatings over the temperature range of 20-50° C. has been shown in the FIGS. 1-6. The shear thinning behaviour of the polymer coatings developed are apparent from the figures.

With increase in shear rate from 1 to 2000 l/s the viscosity drops dramatically over three decades in value. The viscosity also decreases with temperature, but the change is much less pronounced.

Rheological data for the samples at selective shear rates are shown in Table 4.

TABLE 4
Characteristics of the coating formulation and the dry coating

| | | Sample 1 | Sample 2 | Sample 3 | Sample 4 | Sample 5 | Sample 6 |
|---|---|---|---|---|---|---|---|
| | | Solid content wt % | | | | | |
| | | 45.89 | 45.89 | 45.89 | 45.89 | 45.89 | 45.89 |
| | Shear | pH | | | | | |
| | Rate (l/s) | 9.2 | 9.2 | 9.2 | 9.2 | 9.2 | 9.2 |
| η, Viscosity | 10 | 63 | | 84 | 70 | 70 | 107 |
| PaS | 100 | 7.05 | 5.3 | 8.2 | 7.06 | 4.5 | 6.18 |
| | 1000 | 1.54 | 1.30 | 3.8 | 1.48 | 0.72 | 0.99 |
| | 1500 | 0.75 | 0.70 | 1.04 | 1.01 | 0.60 | 0.68 |
| | η∝ | | | | 0.65 | 0.35 | 0.25 |
| Swelling in | 24 h | 14.9 | 13.0 | 13.9 | 13.9 | 14.8 | 12.8 |
| Water (%) | 48 h | 20.6 | 14.5 | 17.9 | 21.3 | 16.00 | 16.48 |
| | | 32.54 | 13.43 | 14.63 | 26.29 | 18.11 | 23.00 |
| Swelling in | 1 h | Disintegrate | 377 | 383 | Disintegrate | 432 | 404 |
| chloroform | | | | | | | |
| (%) | | | | | | | |

The infinite viscosity (η∝) data obtained using the Cross Model, a predictive model used to calculate theoretical viscosity beyond the experimental shear rate ranges, is shown in the table for the selected formulations. The overall characteristics of the different coatings are similar. However, the styrene acrylate based coating (Sample 4) has relatively higher viscosity compared to the acrylate based formulation (Sample 6) at higher shear rates.

The various shear rates as related to application processes are shown in Table 5.

TABLE 5
Shear Rates Typical of Familiar Materials and Processes
(Steffe, 1996)*

| | Shear | |
|---|---|---|
| | Rate, | |
| Situation | (1/s) | Application |
| Sedimentation of | 10⁻⁶-10⁻³ | Medicines, paints, spices in salad dressing |
| particles in a | | |
| suspending liquid | | |
| Levelling due to | 10⁻²-10⁻¹ | Frosting, paints, printing inks |
| surface tension | | |
| Draining under | 10⁻¹-10¹⁻ | Vats, small food containers, painting and |
| gravity | | coating |
| Extrusion | 10⁰-10³ | Snack and pet foods toothpaste, cereals, |
| | | pasta, polymers |
| Calendering | 10¹-10² | Dough sheeting |
| Pouring from a | 10¹-10² | Foods, cosmetics, toiletries |
| bottle | | |
| Chewing and | 10¹-10² | Foods |
| swallowing | | |
| Dip coating | 10¹-10² | Paints, confectionery |
| Mixing and | 10¹-10³ | Food processing |
| stirring | | |
| Pipe flow | 10⁰-10³ | Food processing, blood flow |
| Rubbing | 10²-10⁴ | Topical application of creams and lotions |
| Brushing | 10³-10⁴ | Brush painting, lipstick, nail polish |
| Spraying | 10³-10⁵ | Spray drying, spray painting, fuel |
| | | atomisation |
| High speed | 10⁴-10⁶ | Paper |
| coating | | |
| Lubrication | 10³-10⁷ | Bearings, gasoline engines |

*Steffe, J. F. 1996. Rheological Methods in Food Process Engineering, second edition. Freeman Press, 2807 Still Valley Drive, East Lansing, MI 48823.

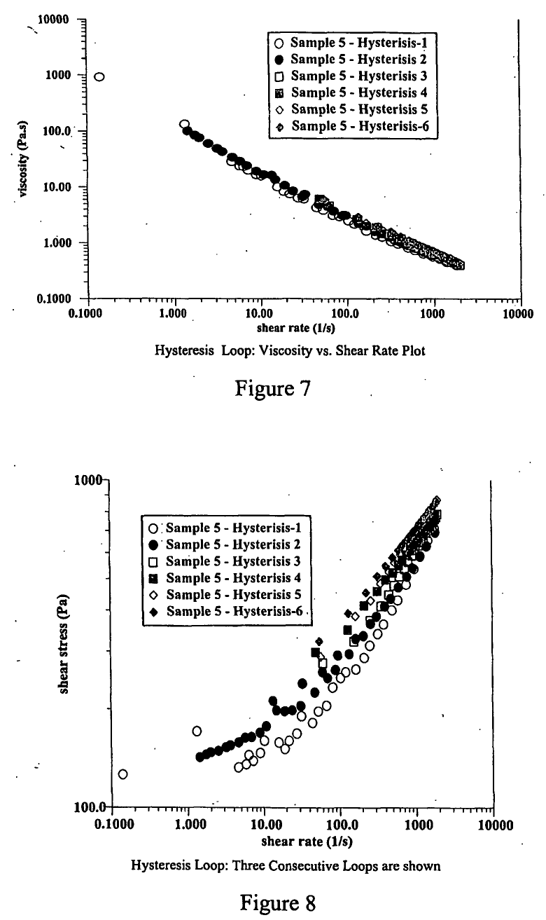

The formulation has been designed to achieve outstanding thickening and anti-settling characteristics. In particular the hydrophilic silica has —OH groups on the surface, which display a tendency to hydrogen bond. In the formulated coating these silanol groups tend to link via hydrogen bonding to form a stable three-dimensional structure, which creates an increase in viscosity of the system and at the same time prevents formulation solids from floating or settling. The three dimensional structure tends to break down under the application of shear force (stirring, shaking, brushing, spraying) resulting in a dramatic decrease in viscosity that provides good spraying characteristics. After removal of the shear forces the three-dimensional structure is built up again and the viscosity increases again (FIG. 7,8).

This increase in viscosity helps the formulation not to run/sag after application to an angular surface.

Other viscosity improvers/modifiers added to the formulations (Table 3) strengthen the network formation. This effect is significantly important if a thick layer of coating is to be employed. The shear thinning also helps to achieve excellent coverage when spraying of the formulation is undertaken.

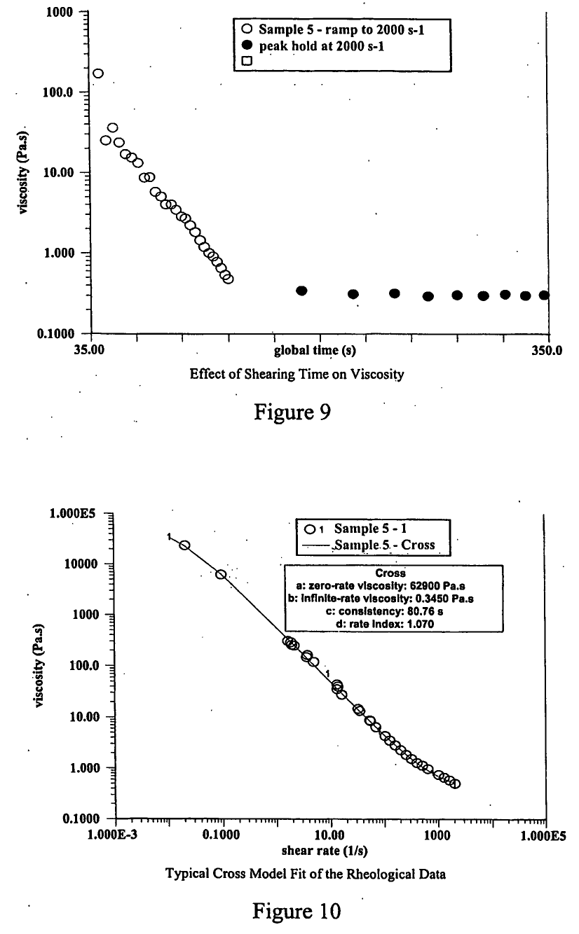

FIG. 9 shows that the viscosity of the coating is shear thinning but not time dependent (thixotropic)—that is the viscosity does not diminish with the increased time of application of shear. The plot of shear stress vs. shear rate for shear thinning system provides a continuous curve convex to the shear stress axis as the shear rate is increased to the maximum. If the shear rate is decreased, a hysteresis loop is created. The thixotropy is related to the area under the hysteresis loop. The hysteresis loop experiment (FIGS. 7,8) confirms that the hysteresis loop is not significant, which further proves quick recovery (the internal force rebuilds the structure as fast as the shearing force breaks it down) and time independent nature of the coating emulsions.

FIG. 10 shows a typical Cross Model fit of the rheological data, which is helpful in determining the viscosity at shear rates beyond the experimental limit.

Spraying Ability of the Coatings

A conventional hand spray gun—the most common tool of industrial coating application has been employed to understand the spray-ability of the developed coating. The basic principle of the spray gun is to atomise the coating into a fine spray and direct the spray onto the object to be coated. Many supplementary components such as a source of compressed air, flow control valves, filtration units for removal of dirt, oil and water from the air supply and container for the coating supply is also necessary.

This process has the advantage of the speed and control of the application. It was observed that a hand spray gun with ‘gravity feed’ bowl and nozzle diameter of ˜2.5 mm is suitable for the atomisation and even spray of the coating on the sample road surface. The coating formed on the sample road surface was uniform.

No flooding and floating occurred in the coating system though it contains a combination of different formulation solids. Flooding and floating normally takes place after application, when the film is still wet, and is caused by the separation of the formulation solids concentrating on the surface. These are caused by the currents that develop during the drying process of the coating film, by the different mobility of the various multi functional solids present, and by the flocculation, which occurs in the wet film. Thus the spray equipment may be suitable for application of large volume of coating. High volume, low-pressure air spray was observed to be suitable for the developed coating.

Intimate contact of the coating with the road surface and hence cleanliness will influence the coating adhesion and is critical for the dry film performance. The ideal time to apply the coating is when weather is warm and dry, with little wind. High humidity may cause condensation of moisture and interfere with bonding of the coating. On the other hand low humidity may cause rapid evaporation of water and cause film cracking. At very low temperature the viscosity may increase significantly. High temperatures may cause over spray, trapped air or carrier bubbles, etc.

Scanning Electron Microscopy (SEM)

SEM has been used successfully for the investigation of surface morphology and fractured surface of the polymer. SEM micrographs provide much higher resolution compared to a light microscope.

In this investigation SEM was used to study the quality of the film formation, coalescence characteristics, solids distribution characteristics and the topography of the film formed. SEM micrograph in FIG. 11 shows the fracture surface of the film of Sample 3. The fractograph clearly indicates the brittle nature of the failure. FIG. 12 represents a close view of the fracture surface of Sample 3 film. Sample 1 also exhibits brittle failure.

FIG. 13 shows an SEM micrograph of the cross sectional view of the coating film. The dynamics of the film formation process from the wet coating is clearly observed from the cross section of the dry film. The very fine particles are evenly distributed in the matrix in the top layer of the film.

The bigger crumb rubber particles, and other larger solids particles and agglomerates form the bottom layer of the film.

Higher magnification view FIGS. 14 and 15 of the bulk of the coating clearly confirms that the vehicle completely displaces the air and carrier and coats the surface of the particles. The interface form is seamless (no air gap, crack mark or void observed). The unique interfacial behaviour of the coating is clearly visible from the very high magnification SEM micrograph, FIG. 15.

FIGS. 16, 17 and 18 illustrate the EDX analysis of the rubber particle, the bulk coating and the interfacial region and the chemistry observed is to be as expected. The crumb rubber particles were observed to be more uniformly distributed in the matrix with the modification of the crumb rubber, FIGS. 19-21 as observed in the case of Sample 5. The observation clearly indicates the importance of the particle sizes, particularly of the crumb rubber and the advantage of the modification. The integrated nature of the interface is also visible from the high resolution SEM picture of the coating sections FIGS. 22 and 23

Wetting Ability and Adhesion

Adhesion is a surface property relevant in many applications of many polymers and coatings. It is the ability to join two dissimilar materials. Good adhesion performance is observed when sufficient intimate intermolecular contact is achieved at the interface. The adhesion characteristics of all the coatings appear to be good.

FIGS. 24 and 25 show the representative topography of the coating surface formed on a smooth glass surface. The typical topography appears to be not very smooth, mainly due to the presence of crumb particles, which are 150<d, 500μ. However, it is clearly observed that the vehicle or the liquid phase wets the solids and the crumb rubber phase and forms a continuous film over the formulation solids and crumb rubber surfaces. FIG. 26 shows the SEM micrograph of the adhesion failure pattern of Sample 5 coated on a glass surface. The adhesion appears to be very strong and the cohesive nature of failure is clearly visible from the figure.

The coating has excellent adhesion on glass, plastic and the test road surface. The modified coatings exhibited outstanding adhesion to the surfaces and these films always exhibited cohesive failure. Sample 1 exhibits brittle failure pattern, whereas Sample 6 exhibited significant elasticity. The adhesion of the film with the test road surface appears to be excellent for all of the modified coatings, however Sample 6 displays the best characteristics.

FIG. 27 shows the EDX analysis of the coating

The method and composition of the present invention provides for protection of weathered asphalt surfaces from degradation whilst utilising the inherent structural capacity of the existing asphalt wearing course. The present invention also avoids the use of seal coatings containing bitumen, cement, coal tar or coal tar derivatives.

Comparative Accelerated Testing

Samples of asphalt binder, asphalt emulsion, polymer modified asphalt slurry and the current invention were prepared on 5 mm×152 mm×76 mm float glass tiles and exposed to accelerated weathering in a QUV accelerated weathering chamber using 340 nm lamps generally in accordance with ASTM G53-88. Samples were exposed for a total of 400 hours under an alternating lamp/condensation cycle comprising 4 hours light cycle at 60±3° C. and 4 hours condensation/dark cycle at 48±3° C.

At the conclusion of the comparative testing the following results were noted;

| | |
|---|---|
| Asphalt Binder | Coating lifted from glass substrate, softened and |
| | melted |
| Asphalt Emulsion | Asphalt emulsion melted and little coating remained |
| | on the glass substrate. |
| Polymer Modified | Substantial colour change from brown/black to light |
| Asphalt Slurry | grey. Significant cracking through layer under |
| | 50X magnification |
| Current Invention | No noticeable change |
| Sample 6 | |

A shear thinning formulation having the composition of Sample 6, was prepared onto a weathered low traffic volume road displaying an average pre coating pavement texture depth of 1.48 mm. Post coating texture depth tests show a decrease in the average pavement texture depth to 1.33 mm, demonstrating the benefit of the shear thinning formulation used.

The coating provides an attractive finish to the aged roadway over a range of inclines and minor surface cracking evident on the roadway was sealed. The coating displayed excellent adhesion to the asphalt/sand mixture contained within the voids of the roadway surface and dried quickly, enabling traffic to reuse the road after 20 minutes from coating application.

1. A method for treating a weathered low volume asphalt surface comprising the steps of:
providing a composition comprising a solution, emulsion or dispersion of a polymer binder material, particulate material and rheology modifiers,
wherein the composition is essentially free of bituminous components and is essentially free of cement; and
applying the composition to the asphalt surface.

2. The method of claim 1, wherein the composition is applied to the asphalt surface using high volume, low pressure (HVLP) equipment.

3. The method of claim 1, wherein the composition is applied to the asphalt surface using a mechanized squeegee or slurry machine.

4. The method of claim 1, wherein the solution, emulsion or dispersion of a polymeric material includes at least one polymeric material that forms a film upon setting.

5. the method of claim 4, wherein the polymeric material is an aqueous dispersion of an acrylic polymer or copolymer.

6. The method of claim 1 wherein the particulate material is at least one material selected from the group of sand, mineral aggregates, rubber particles or a mixture of two or more materials.

7. The method of claim 1, wherein the composition forms a shear thinning formulation characterised by a markedly reduced viscosity when the formulation is subject to shear forces.

8. The method of claim 7, wherein the shear thinning formulation exhibits a reduction in viscosity as the formulation is applied by spraying and increases in viscosity after application.

9. The method of claim 7, wherein the composition exhibits a decrease in viscosity of at least two orders of magnitude when subjected to a shear rate increase from 1-2000 l/s.

10. The method of claim 6, wherein the particulate material is rubber particles, having a maximum particle size of less than 500 μm.

11. The method of claim 6, wherein the particulate material is rubber particles, having a maximum particle size of less than 250 μm.

12. The method of claim 1, wherein the composition is applied to a depth such that any protruding aggregate in the asphalt surface is substantially not covered by the composition.

13. The method of claim 1, wherein the application rate of the composition to the asphalt surface will result in a coating thickness between about 200 to 300 μm being applied to the asphalt surface.

14. A composition for treating a weathered low traffic volume asphalt surface comprising:
A solution, emulsion or dispersion of a polymeric material, particulate material and rheology modifiers;
wherein the composition is essentially free of cement and is essentially free of bituminous components.

15. The composition of claim 14, wherein the solution, emulsion or dispersion of a polymeric material includes at least one polymeric material that forms a film upon setting.

16. The composition of claim 14, wherein the polymeric material is an aqueous emulsion of an acrylic polymer or copolymer.

17. The composition of claim 14, wherein the composition is a shear thinning formulation characterized by a markedly reduced viscosity when the formulation is subject to shear forces.

18. The composition of claim 17, wherein the shear thinning formulation exhibits a marked reduction in viscosity as the formulation is applied by spraying and increases in viscosity after application.

19. The composition of claim 17 wherein the composition exhibits a decrease in viscosity of at least two orders of magnitude when subjected to a shear rate increase from 1-2000 l/s.

20. The composition of claim 14, wherein the particulate material is rubber particles having a maximum particle size of less than 500 μm.

21. The composition of claim 14, wherein the particulate material is rubber particles having a maximum particles size of less than 250 μm.
